(19) United States
(12) Patent Application Publication
(10) Pub. No.: US 2002/0127421 A1
(43) Pub. Date: Sep. 12, 2002

(54) Blown film

(75) Inventors: Masanori Fukada, Ichihara-shi (JP); Tatsuya Kasahara, Sodegaura-shi (JP); Tatsuhiro Nagamatsu, Ichihara-shi (JP)

Correspondence Address: FITCH EVEN TABIN AND FLANNERY, 120 SOUTH LA SALLE STREET, SUITE 1600, CHICAGO, IL, 60603-3406, US

(73) Assignee: Sumitomo Chemical Company, Limited

(21) Appl. No.: 10/024,521

(22) Filed: Dec. 21, 2001

(30) Foreign Application Priority Data
Dec. 25, 2000 (JP) 2000-392263

(51) Int. Cl. B32B 27/08; B32B 27/32

(52) U.S. Cl. 428/516; 428/141

(57) ABSTRACT

The object of this invention is to provide a blown film which even if it is thin, is strong, feels firm and has high transparency and this invention provides a blown film comprising a multi-layer film of 3 or more layers comprising surface layers made of linear low-density polyethylene 1 satisfying the following requirements (A) to (C) and middle layers, wherein at least one of the middle layers is a layer comprising a resin composition comprising low-density polyethylene and linear low-density polyethylene 2 having a crystallization temperature higher by at least 2° C. than the crystallization temperature of the linear low-density polyethylene 1, as well as a blown film having a haze value of 7% or less, a tear strength of at least 110 kN/m in the MD direction, and a 1% secant modulus (1% SM) of at least 190 MPa.

(A): a composition distribution variation coefficient (Cx) represented by the following equation (1) is not more than 0.5,

Cx=σ/SCBave (1)

wherein σ is a standard deviation of composition distribution, and SCBave is an average branching degree,

(B): a content (a) of cold xylene-soluble portion in terms of % by weight based on the weight of the linear low-density polyethylene 1 and the density (d) satisfy the following inequality (2),

a<4.8×10⁻⁵×(950−d)³+10⁻⁶×(950−d)⁴+1 (2)

(C): a crystallization temperature (Tc) and a density (d) satisfy the following inequality (3),

Tc>0.763×d−599.2 (3)

### FIELD OF THE INVENTION

The present invention relates to a blown film.

### BACKGROUND OF THE INVENTION

The blown film is used often in packaging. Recently, such film is required to be thinner because of the influence of enforcement of the bottle-recycling law, etc.

However, when the film was made thinner in accordance with such demand, the strength and handling properties of the film were deteriorated under the present circumstances, thus making it difficult to sufficiently satisfy the fundamental performance required of the film.

Under these circumstances, the object of this invention is to provide a blown film, which, even if it is made thinner, has sufficient strength and high transparency.

### SUMMARY OF THE INVENTION

This invention provides a blown film comprising a multi-layer film of 3 or more layers comprising surface layers made of linear low-density polyethylene 1 satisfying the following requirements (A) to (C) and middle layers, wherein at least one of the middle layers is a layer comprising a resin composition comprising low-density polyethylene and linear low-density polyethylene 2 having a crystallization temperature higher by at least 2° C. than the crystallization temperature of the linear low-density polyethylene 1, as well as a blown film having a haze value of 7% or less, a tears strength of at least 110 kN/m in the MID direction, and a 1% secant modulus (1% SM) of at least 190 MPa.

(A): a composition distribution variation coefficient (Cx) represented by the following equation (1) is not more than 0.5,

Cx=σ/SCBave (1)

wherein a is a standard deviation of composition distribution, and SCBave is an average branching degree,

(B): a content (a) of cold xylene-soluble portion in terms of % by weight based on the weight of the linear low-density polyethylene 1 and the density (d) satisfy the following inequality (2),

a<4.8×10⁻⁵×(950−d)³+10⁻⁶×(950−d)⁴+1 (2)

(C): a crystallization temperature (Tc) and a density (d) satisfy the following inequality (3),

Tc>0.763×d−599.2 (3)

### DETAILED DESCRIPTION OF THE INVENTION

Hereinafter, this invention is described in more detail.

As one indicator of film transparency, there is a haze value whose lower value is indicative of higher transparency. For application where transparency is necessary, a film of higher transparency is excellent in see-through. The blown film of this invention comprises a multi-layer film of 3 or more layers comprising of surface layers made of linear low-density polyethylene 1 satisfying the following requirements (A) to (C) and middle layers, wherein at least one of the middle layers is a layer comprising a resin composition comprising low-density polyethylene and linear low-density polyethylene 2 having a crystallization temperature higher by at least 2° C. than the crystallization temperature of the linear low-density polyethylene 1.

(A): a composition distribution variation coefficient (Cx) represented by the following equation (1) is not more than 0.5,

Cx=σ/SCBave (1)

wherein C is a standard deviation of composition distribution, and SCBave is an average branching degree,

(B): a content (a) of cold xylene-soluble portion in terms of % by weight based on the weight of the linear low-density polyethylene 1 and the density (d) satisfy the following inequality (2),

a<4.8×10⁻⁵×(950−d)³+10⁻⁶×(950−d)⁴+1 (2)

(C): a crystallization temperature (Tc) and a density (d) satisfy the following inequality (3).

Tc>0.763×d−599.2 (3)

The linear low-density polyethylene 1 used in both the surface layers is obtained usually by gas phase polymerization using a single-site catalyst. As used herein, the single-site catalyst is a catalyst capable of forming a uniform active species, and is prepared by usually contacting a metallocene-based transition metal compound or a non-metallocene-based transition metal compound with an activating promoter.

The linear low-density polyethylene obtained by gas phase polymerization using such a single-site catalyst is preferably used in the film of this invention because of its excellent tear strength (in particular tear strength in the MD direction).

A single site catalyst may for example be a catalyst prepared by contacting a metallocene-based transition metal compound with an activating promoter, more preferably a catalyst prepared by bringing a metallocene-based transition metal compound represented by Formula MLaXn-a (wherein M denotes the 4th or lanthanoid transition metal atom on the IUPAC periodic table, L denotes a group having a cyclopentadiene-type anion backbone or a group having a heteroatom, and at least one is a cyclopentadiene-type anion backbone, several Ls may be crosslinked, X denotes a halogen atom, a hydrogen atom or a hydrocarbon group having 1 to 20 carbon atoms, n denotes the atomic valency of the transition metal atom M and a is an integer which satisfies 0<a≦n) with an activating promoter, and said transition metal compound may be employed alone or in combination one or more of such metals. An activating promoter may for example be one capable of giving an olefin polymerization activity by being employed together with a metallocene-based transition metal compound or a non-metallocene-based transition metal compound, such as an organic aluminium compound containing an alumoxane compound and/or a boron compound such as triphenylmethyl tetrakis (pentafluorophenyl) borate) N,N-dimethylanilinium tetrakis (pentafluorophenyl) borate and the like. As a single site catalyst a combination of particulate carriers including an inorganic carrier such as SiO₂ and Al₂O₈ and an organic polymer carrier such as polymers of ethylene and styrene.

The linear low-density polyethylene refers to a copolymer of an ethylene and α-olefin having 3 to 12 carbon atoms, which copolymer has a polyethylene crystalline structure. The α-olefin having 3 to 12 carbon atoms includes propylene, butene-1,4-methylpentene-1, hexene-1, octene-1, decene-1 etc. In particular, 4-methylpentene-l, hexene-1, octene-1 and decene-1 are more preferable from the viewpoint of tear strength.

The MFR value of the linear low-density polyethylene 1 described above is preferably 0.1 g/10 minutes or more for the purpose of reducing the load onto an extruder, more preferably 0.5 g/10 minutes or more. Also in view of the bubble stability during a blown film extrusion, and the tear strength and the blocking of the obtained film, a MFR value not higher than 50 g/10 minutes, especially, 10 g/10 minutes, is more preferred. An MFR value here means a value determined by the method prescribed in JIS-K 7210 (Temperature 190° C., loading weight 21.8 N).

The density of the linear low-density polyethylene 1 described above is preferably at least 880 kg/m³, more preferably at least 900 kg/m³ in view of the bubble stability during a blown film extrusion, Also in view of the optical characteristics and the tear strength of a resultant film, the density is preferably 937 kg/m³ or less, more preferably 925 kg/m³ or less. A density here means a value determined by the method prescribed in JIS-K 6760-1981.

A composition distribution variation coefficient (Cx) represented by the above-mentioned equation (1) is not more than 0.5, preferably from 0.2 to 0.4. When the composition distribution variation coefficient exceeds 0.5, tear strength and anti-blocking property thereof may deteriorate.

The composition distribution variation coefficient is a measure showing a distribution degree of the monomer unit in the linear low-density polyethylene. The smaller the Cx value, the narrower the composition distribution, in other words, the ethylene unit and the α-olefin unit are more uniformly distributed in the linear low density polyethylene. A measurement method of the Cx value is mentioned hereinafter.

A content (a) (% by weight) of cold xylene-soluble portion and a density (d) of the linear low density polyethylene 1 satisfy the above-mentioned inequality (2). A linear low-density polyethylene 1 satisfying the following inequality (4) is preferred, and a linear low-density polyethylene 1 satisfying the following inequality (5) is more preferred.

a<4.8×10⁻⁵×(950−d)³+10⁻⁶×(950−d)⁴+1 (4)

a<4.8×10⁻⁵×(950−d)³+1 (5)

When the linear low-density polyethylene 1 does not satisfy the above inequality (2), tear strength of the film may decrease, and anti-blocking property may deteriorate.

A crystallization temperature (Tc) and a density (d) of linear low-density polyethylene 1 satisfy the above-mentioned inequality (3). When the linear low-density polyethylene 1 does not satisfr the above inequality (3), the frost line is higher and the processing stability during a blown film extrusion is not good. Particularly, in the case where the ratio in thickness of the middle layer to the whole film is small, the effect may become significant. In view of the optical characteristics and the tear strength of a resultant film, Tc is preferably lower than 116° C., more preferably lower than 107° C.

Such linear low-density polyethylene can be obtained by the gas phase polymerization using the single-site catalyst as described above.

Different kinds of linear low-density polyethylene 1 may be used in both the surface layers, respectively.

The low-density polyethylene used in at least one of the middle layers is obtained usually by high-pressure radical polymerization.

The MFR value of the low-density polyethylene is preferably 0.1 g/10 minutes or more for the purpose of reducing the load onto an extruder, more preferably 0.2 g/10 minutes or more. Also in view of the bubble stability during a blown film extrusion, and the tear strength of the obtained film, a MFR value not higher than 100 g/10 minutes, especially, 10 g/10 minutes, is more preferred. From the viewpoint of transparency, the density of the low-density polyethylene is preferably 915 to 930 kg/m³ and the SR value of the low-density polyethylene is preferably from 1.3 to 1.6, more preferably from 1.3 to 1.50. SR is D/D₀ wherein D₀ is a diameter of an orifice used for measuring MFR and D is a diameter of the strand extruded from the orifice.

The crystallization temperature of the linear low-density polyethylene 2 is higher by at least 2° C. than the crystallization temperature of the linear low-density polyethylene 1. From the viewpoint of transparency, the crystallization temperature of the linear low-density polyethylene 2 is preferably higher by at least 4° C. than the crystallization temperature of the linear low-density polyethylene 1. More preferably, the crystallization temperature of the linear low-density polyethylene 2 is sufficiently high so that the film surface becomes less uneven to improve transparency. When different kinds of linear low-density polyethylene 1 are used in both the surface layers respectively, the crystallization temperature of the linear low-density polyethylene 2 shall be higher by at least 2° C. than the crystallization temperature of the linear low-density polyethylene 1 having a higher crystallization temperature.

The density of the linear low-density polyethylene 2 is preferably at least 900 kg/m³, more preferably at least 920 kg/m³ in view of the bubble stability during a blown film extrusion. Also in view of the optical characteristics and the tear strength of a resultant film, the density is preferably 940 kg/m³ or less, more preferably 935 kg/m³ or less.

From the viewpoint of the tear strength of the resulting film, the linear low-density polyethylene 2 is more preferably a linear low-density polyethylene obtained by polymerization using the single-site catalyst.

The blending ratio of the low-density polyethylene in the whole of the resin composition is preferably 5 to 50% by weight, more preferably 10 to 30% by weight. The blending ratio in this range is preferable because not only bubble stability during a blown film extrusion but also the transparency and tear strength of the film are good.

With regard to the relationship between the MFR values of the linear low-density polyethylene 1 and the resin composition comprising both the low-density polyethylene and the linear low-density polyethylene 2, the MFR value of the resin composition is equal to or less than that of the linear low-density polyethylene 1, in view of the appearance of a resultant film. When the MFR value of one side of the both surface layers is different from that of the other, the lower MFR value serves as a basis.

While the layer ratio of a multilayer film is not limited particularly, the surface layers: the middle layers is preferably 4:1 to 1:4 in view of the productivity and the balance between the physical characteristics.

When the middle layer consists of two or more layers, it is preferable that one of the layers satisfies the above condition.

Further, the blown film of this invention has a haze value of 8% or less, a tear strength of at least 110 kN/m in the MD direction, and a 1% secant modulus (1% SM) of at least 190 MPa. The haze value can depend on film thickness, and generally, as the thickness is increased, the haze value tends to be increased. The haze value of the blown film in this invention is a value of the film whose thickness is 50 μm or less, and the haze value is more preferably 5% or less when the thickness is 30 μm or less.

The haze value is divided into the outer haze attributed to the surface of the film and the inner haze from the inside of the film, and each haze can be estimated. The roughness of the film surface influences the outer haze and gloss, and generally, as the unevenness of the surface is increased, the outer haze and gloss are deteriorated, while as the unevenness is decreased, the outer haze and gloss are improved. The average roughness Ra of the film surface in this invention is preferably 30 nm or less.

The tear strength of the blown film of this invention is at least 110 kN/m in the MD direction, preferably 130 to 300 kN/m. The blown film of this invention is a strong film having high tear strength even if it as made thin.

The 1% secant modulus (1% SM) of the blown film of this invention is 190 MPa or more, preferably 220 to 300 MPa. It is not preferable that the 1% SM value is too low because the body of the film becomes soft and is inferior in suitability for automatic packaging or in handling properties such as opening properties. The 1% SM value of the blown film of this invention is sufficiently high so that even if the thickness is decreased, the film has high strength and is superior in suitability for automatic packaging and opening properties, and thus has fundamental requirements for achieving a thinner film.

As the blown film satisfying the above physical properties, there can be exemplified the above-described blown film comprising a multi-layer film of 3 or more layers consisting of surface layers made of linear low-density polyethylene 1 and middle layers, wherein at least one of the middle layers is a layer consisting of a resin composition comprising low-density polyethylene and linear low-density polyethylene 2 having a crystallization temperature higher by at least 2° C. than the crystallization temperature of the linear low-density polyethylene 1.

Generally, the process for producing a blown film includes an air-cooling blown-film extrusion and water-cooling blown-film extrusion depending on the cooling method. Either cooling method may be used for the film of this invention, but the air-cooling method is preferable from the viewpoint of productivity.

The air-cooled blown film of this invention is produced by film processing through air-cooling blown-film extrusion for example by using the linear low-density polyethylene 1 as both the surface layers and the resin composition comprising low-density polyethylene and the linear low-density polyethylene 2 as at least one layer of the middle layers as described above.

The processing conditions are usually as follows: the processing temperature is in the range of 140 to 220° C., the blow up ratio is 1.5 to 6.0, the take-off speed is 5 to 150 m/min., and the thickness is 10 to 200 μm.

### EXAMPLES

Hereinafter, this invention is described by reference to the Examples. However, the following examples are described merely for illustrative purposes, and this invention is not limited to the following examples.

Methods for evaluation etc. are as follows:

(a) Composition Distribution Variation Coefficient (Cx)

It was measured by using a multifunction LC (Liquid Chromatography) manufactured by Tosoh Corporation according to a process comprising the following steps (1) to (6).

(1) A sample is dissolved in o-dichlorobenzene (ODCB) heated at 145° C. to obtain a solution having a concentration of 0.2 g/20 ml.

(2) The solution is introduced in a column of a column oven, in which sea sand is filled.

(3) A temperature of the oven is lowered from 145° C. to 125° C. at a rate of 40° C./60 minutes, and further lowered from 125° C. to −15° C. over 14 hours.

(4) The temperature of the oven is raised from 15° C. to 125° C. at a rate of 10° C./60 minutes with flowing ODCB at 2.5 ml/min., and a relative concentration of the sample in the solution continuously effused from the column during the temperature-raising process is measured with use of an FT-IR connected to the column. Here, the relative concentration is measured at each 1° C. from −15 to 110° C. during the time that the oven temperature is raised by 10° C. (for example, during the time that the oven temperature is raised from −15° C. to −5° C.), and a final temperature of the measurement is fixed to be a temperature (about 97° C.) at which the SCB value according to the following equation (7) is found to be almost 0. The reason why the oven temperature is raised to 125° C. is to perfectly effuse the sample from the column.

(5) On the other hand, a branching degree (SCB) per 1000 carbon atoms of a principal chain in each temperature (each effusion temperature) at which the relative concentration is measured is determined from the following equation (6) regardless of a kind of the comonomer.

SCB=−0.7322×effusion temperature(° C.)+70.68 (6)

(6) With respect to each temperature at which the relative concentration is measured, the branching degree obtained in the above item (5) and the relative concentration obtained in the above item (4) are plotted to enter the horizontal axis and the vertical axis, respectively, thereby obtaining a curve (composition distribution curve).

(7) From the curve, an average branching degree per 1000 carbon atoms (SCBave.) and a standard deviation (σ) of composition distribution are obtained, and from the following equation (1), a fluctuation coefficient (Cx) of composition distribution is determined.

Cx=σ/SCBave (1)

Here:

Average branching degree (SCBave.)=ΣN(i)×W(i)

Standard deviation (a) of composition distribution={Σ(N(i)−SCBave.)²×W(i)}^{0.5}

N(i): Branching degree at No. i measuring point.

W(i): Relative concentration at No. i measuring point (σW(i)=1).

(b) Content of Cold Xylene-Soluble Portion (a) (% by Weight)

Measured by a method prescribed in §175.1520 of U.S. Code of Federal Regulations, Food and Drugs Administration.

(c) Crystallization Temperature (Unit: ° C.)

A differential scanning calorimeter (DSC manufactured by Perkin Elmer) was employed to melting 10 mg of a sample by heating under nitrogen atmosphere at 150° C. for 4 minutes followed by cooling to 40° C. at a rate of 5° C./min. The temperature at which the maximum peak in a curve was observed was regarded as the crystallization temperature.

(d) Haze (Unit: %)

Measured by a method prescribed in JIS-K 210.

(e) Tear Strength (Unit: kN/m)

Measured by a method prescribed in JIS-K 7128.

(f) 1% Secant Modulus (Abbreviated Hereinafter to “1% SM”) (Unit: MPa)

The film was cut in the manufacturing direction (MD) or in the traverse direction (TD) into test specimens of 2 cm in width, and the test specimens were attached at 6·cm chuck intervals in a tensile machine, and drawn at a rate of 5 mm/min., and from the stress at 1% elongation, 1% SM was calculated using the formula of 100×(stress)/(sectional area) [MPa].

(g) Average Roughness Ra of the Film Surface (Unit: nm)

<Sampling>

The surface of a film was rinsed with acetone for 1 minute and then fixed on a sample mount using a double adhesive tape. Subsequently, the sample was made free of static sufficiently using a static remover (*DYNAC* PB-160B manufactured by *FISA*).

<Measurement>

An atomic force microscope (AYM) was employed to measure the unevenness of the surface of a sample (measured vision: 100 μm×100 μm)

Observation Conditions

Observation unit: Model D3000 large scale sample observation system (Manufactured by Digital Instrument)

Controlling unit: NanoScope IIIa (Manufactured by Digital Instruments: Ver.4.23rl)

Measurement mode: Tapping

Data type: Height

Scan rate: 0.5 to 1 Hz

Number of lines: 512 lines

Number of data points: 512 points/line

Slope correction: Slope correction was performed using “Real time Planefit” function (Line).

Probe Employed

Name: TESP Manufactured by Nanosensors)

Material: Si single crystal

Cantilever shape: Single beam type

Cantilever spring constant: 21 to 78 N/m

Probe tip curvature radius: 5 to 20 nm

Probe length: 10 to 15 μm

Probe ½ cone angle: About 18 degrees

<Data Processing>

The “Flatten” function (Order 1) of the AFM controlling software was employed to correct for a curve and to remove a noise.

An image after curve correction and noise removal was subjected to a calculation of the average roughness Ra of a film surface using the “Roughness” function of the AFM controlling software.

Software Employed

Name: NanoScope IIIa (Digital Instruments; Ver.4.23rl)

### Example 1

SUMIKATHEN E FV403 (density=919 kg/m³, MFR=4 g/10 min, Tc=104° C.), which is ethylene-hexene-1 copolymer manufactured by Sumitomo Chemical Co., Ltd. using a gas-phase process with metallocene type catalyst, was used in both the surface layers, while a resin mixture prepared by dry-blending 80 parts by weight of SUMIKATHEN E FV404 (density=927 kg/ma, MFR=4 g/10 min., crystallization temperature=109° C.), which is ethylene-hexene-1 copolymer manufactured by Sumitomo Chemical Co., Ltd. using a gas-phase process with metallocene type catalyst, with 20 parts by weight of SUMIKATHEN F200-0 (density=923 kg/m³, MFR=2 g/10 min.), which is low-density polyethylene manufactured by Sumitomo Chemical Co., Ltd. using a high-pressure radical polymerization process, was used in the middle layer, and a blown film was produced under the following processing conditions.

[1] Blown film processing machine: Coextrusion blown film line manufactured by PIACO Co., Ltd.

[2] Die: Three-kind three-layer coextrusion die, Die size: 150 mm ID, Lip gap. 2.0 mm

[3] (Processing temperature: 150° C.

[4] Output: 40 Kg/hr

[5] Total thickness: 50 μm

[6] Blow up ratio: 2.2

[7] Winding speed: 14 m/min

[8] Layer ratio: Inner layer: middle layer: outer layer=1:2:1

### Example 2

A blown film was produced under the same processing conditions as in Example 1 except that a resin mixture prepared by dry-blending 80 parts by weight of SUMIKATHEN α FZ203-0 (density=931 kg/m³, MFR=2 g/10 min., crystallization temperature=111° C.), which is ethylene-hexene-1 copolymer produced by Sumitomo Chemical Co., Ltd. using high-pressure ion polymerization process with a multi-site catalyst, with 20 parts by weight of the above-mentioned SUMIKATHEN F200-0 was used in the middle layer, and the processing temperature was 170° C.

### Comparative example 1

A blown film was produced under the same processing conditions as in Example 1 except that the above-mentioned SUMIKATHEN E FV403 was used in both the surface layers and in the middle layer.

### Comparative Example 2

A blown film was produced under the same processing conditions as in Example 1 except that a resin mixture prepared by dry-blending 80 parts by weight of the above-mentioned SUMIKATHEN E FV403 with 20 parts by weight of the above-mentioned SUMIKATHEN F200-0 was used in both the surface layers and in the middle layer,

### Comparative Example 3

A blown film was produced under the same processing conditions as in Example 1 except that the above-mentioned SUMIKATHEN E FV403 was used in both the surface layers, and the above-mentioned SUMIKATHEN E FV404 was used in the middle layer.

### Comparative Example 4

A blown film was produced under the same processing conditions as in Example 1 except that SUMIKATHIEN α FZ202-0 (density=921 kg/m³, MFR=2 g/10 min, which is ethylene-hexene-1 copolymer produced by Sumitomo Chemical Co., Ltd. using high-pressure ionization polymerization process with a multi-site catalyst, was used in both the surface layers, while a resin mixture prepared by dry-blending 80 parts by weight of the above-mentioned SUMIKATHEN α FZ203-0 with 20 parts by weight of the above-mentioned SUMIKATHEN F200-0 was used in the middle layer, and the processing temperature was 170° C.

### Comparative Example 5

A blown film was produced under the same processing conditions as in Example 1 except that a resin mixture prepared by dry-blending 80 parts by weight of SUMIKATHEN E FV402 (density=915 kg/m³, MFR=4 g/10 min., crystallization temperature=104° C.), which is ethylene-hexene-1 copolymer produced by Sumitomo Chemical Co., Ltd. using a gas-phase process with metallocene type catalyst, with 20 parts by weight of the above-mentioned SUMIKATHEN F200-0, was used in the middle layer.

TABLE 1

| | Requirements (A) to (C) for the linear | | | | |
|---|---|---|---|---|---|
| | low density polyethylene1 | | | | |
| | (A) | (B) | | (C) | |
| | | | Right side of | | Right side of |
| | Cx | a(wt %) | inequality (2) | Tc(° C.) | inequality (3) |
| FV403 | 0.36 | 1.0 | 3.4 | 104 | 102 |
| FZ202-0 | 0.57 | 2.6 | 2.9 | 106 | 103.5 |

Evaluation Results:

The evaluation results of the resultant various films are shown in Table 2.

TABLE 2

| | Example | Example | Comparative | Comparative | Comparative | Comparative | Comparative |
|---|---|---|---|---|---|---|---|
| | 1 | 2 | Example 1 | Example 2 | Example 3 | Example 4 | Example 5 |
| Average | 19 | 16 | 71 | 29 | 24 | 12 | 69 |
| roughness Ra(nm) | | | | | | | |
| Haze | 5.8 | 7.6 | 33.6 | 8.1 | 11.5 | 6.0 | 27.0 |
| (%) | | | | | | | |
| Tearing | 174 | 186 | 141 | 83 | 165 | 43 | 128 |
| strength(MD) | | | | | | | |
| (kN/m) | | | | | | | |
| 1% SM(MD) | 220 | 230 | 179 | 173 | 214 | 240 | 160 |
| (MPa) | | | | | | | |
| 1% SM(TD) | 220 | 260 | 172 | 191 | 223 | 280 | 166 |
| (MPa) | | | | | | | |

According to this invention, there is provided a blown film which even if it is thin, is strong, feels firm and has high transparency as described above in detail.

What is claimed is:

1. A blown film comprising a multi-layer film of 3 or more layers comprising surface layers made of linear low-density polyethylene 1 satisfying the following requirements (A) to (C) and middle layer(s), wherein at least one of the middle layers is a layer comprising a resin composition comprising low-density polyethylene and linear low-density polyethylene 2 having a crystallization temperature higher by at least 2° C. than the crystallization temperature of the linear low-density polyethylene 1.
(A): a composition distribution variation coefficient (Cx) represented by the following equation (1) is not more than 0.5,
Cx=σ/SCBave (1)
wherein σ is a standard deviation of composition distribution, and SCBave is an average branching degree,
(B): a content (a) of cold xylene-soluble portion in terms of % by weight based on the weight of the linear low-density polyethylene 1 and the density (d) satisfy the following inequality (2),
a<4.8×10⁻⁵×(950−d)³+10⁻⁶×(950−d)⁴+1 (2)
(C): a crystallization temperature (Tc) and a density (d) satisfy the following inequality (3),
Tc>0.763×d−599.2 (3)

2. The blown film according to claim 1, wherein the resin composition comprises 50 to 6% by weight of low-density polyethylene and 50 to 95% by weight of linear low-density polyethylene 2.

3. A blown film having a haze value of 8% or less, a tear strength of at least 110 kN/m in the MD direction, and a 1% secant modulus (1% SM) of at least 190 MPa.

4. The blown film according to claim 3, wherein surface average roughness Ra of the blown film is 30 nm or less.
